(19) United States
(12) Patent Application Publication
(10) Pub. No.: US 2011/0078014 A1
(43) Pub. Date: Mar. 31, 2011

(54) ONLINE RESOURCE ASSIGNMENT

(75) Inventors: Jon Feldman, New York, NY (US); Nitish J. Korula, Urbana, IL (US); Seyed Vahab Mirrokni Banadaki, Brooklyn, NY (US); Shanmugavelayutham Muthukrishnan, New York, NY (US); Martin Pal, Metuchen, NJ (US)

(73) Assignee: GOOGLE INC., Mountain View, CA (US)

(21) Appl. No.: 12/636,362

(22) Filed: Dec. 11, 2009

Related U.S. Application Data
(60) Provisional application No. 61/247,193, filed on Sep. 30, 2009.

(51) Int. Cl. G06Q 30/00; G06F 15/16

(52) U.S. Cl. 705/14.42; 709/226

(57) ABSTRACT

Methods, systems, and apparatus, including computer programs encoded on a computer storage medium, for allocating resources. In one aspect, a method includes receiving an advertisement request and identifying eligible advertisements that are eligible to be provided in response to the advertisement request. For each of the eligible advertisements an impression score corresponding to the advertisement request is received and a discount factor for each eligible advertisement is computed. The discount factor can be computed based on a function of previous impression scores for previous advertisement requests for which the eligible advertisement was provided. Using the impression scores and the discount factors for the eligible advertisements an allocation score is computed for each eligible advertisement. Using the allocation scores, an eligible advertisement is selected and provided in response to the request.

### CROSS-REFERENCE TO RELATED APPLICATIONS

This application claims the benefit under 35 U.S.C. §119(e) of U.S. Patent Application No. 61/247,193, entitled “Online Ad Assignment with Free Disposal,” filed Sep. 30, 2009, which is incorporated herein by reference in its entirety.

### BACKGROUND

This specification relates to content selection.

The Internet provides access to a wide variety of resources, such as video and/or audio files, as well as web pages for particular subjects or particular news articles. Access to these resources has provided opportunities for advertisements to be provided with the resources. For example, web pages can include advertisement slots in which advertisements can be presented. The advertisements slots can be defined in the web page or defined for presentation with a web page, for example, in a pop-up window.

Advertisement slots can be allocated to advertisers through an auction. For example, advertisers can provide bids specifying amounts that the advertisers are respectively willing to pay for presentation of their advertisements. In turn, an auction can be performed and the advertisement slots can be allocated to advertisers according to their bids. For example, when one advertisement slot is being allocated in the auction, the advertisement slot can be allocated to the advertiser that provided the highest bid. When multiple advertisement slots are allocated in a single auction, the advertisement slots can be allocated to set of bidders that provided the highest bids.

Advertisement slots can also be allocated to advertisers based on agreements entered into by publishers and advertisers, where the agreement requires that publisher to allocate to the advertiser at least a threshold number of advertisement slots over a specified period. For example, a publisher can agree, for a fee, to allocate at least 1000 of its available advertisement slots to an advertiser that has paid the publisher $1000. In turn, the publishers advertisement slots can be allocated to the advertiser over the specified period until 1000 advertisement slots have been allocated to the advertiser. Although the threshold number of advertisement slots can be allocated to the advertiser over the specified time, it is sometimes difficult to allocate the advertiser advertisement slots that are of high value to the advertiser because the publisher may not be able to determine which advertisers most value available advertisement slots.

### SUMMARY

A resource can be provided in response to a resource request that is received, for example, from a user device. In some implementations, the resource request is an advertisement requests and the resource provided is an advertisement that is being provided for presentation with an online publisher resource (i.e., an advertisement that is being provided for a publisher web page). The advertisement that is provided is an advertisement for which a cumulative impression value increases the most from being provided in response to the advertisement request. In some implementations, an increase in cumulative impression value for an advertisement can be represented by an allocation score that is computed based on a function of an impression value of the advertisement request and impression values corresponding to previous advertisement requests for which the advertisement was previously presented.

In response to the resource request, advertisements that are eligible to be provided in response to the resource request (“eligible advertisements”) are identified and corresponding impression values (e.g., values of the impression corresponding the resource requests to the advertisers that provided the eligible advertisements) are determined. Using the impression values, allocation scores are computed for each of the eligible advertisements and the eligible advertisement having the highest allocation score are selected to be provided in response to the resource request.

In general, one innovative aspect of the subject matter described in this specification can be embodied in methods that include the actions of receiving, by a data processing apparatus, an advertisement request requesting an advertisement be provided in response to the advertisement request; identifying eligible advertisements that are eligible to be provided in response to the advertisement request; for each of the eligible advertisements, receiving an impression score corresponding to the advertisement request, the impression score representing a value resulting from providing the eligible advertisement in response to the advertisement request irrespective of values of previous advertisement requests for which the eligible advertisement was provided; for each of the eligible advertisements, computing a discount factor for the eligible advertisement, the discount factor being computed based on a function of weighted impression scores corresponding to previous impression scores for previous advertisement requests for which the eligible advertisement was provided, the weighted impression scores being assigned weights that are inversely proportional to the previous impression scores; for each of the eligible advertisements computing, by a data processing apparatus, an allocation score for the eligible advertisement, the allocation score being computed as a function of the impression score corresponding to the advertisement request and the discount factor for the eligible advertisement, the allocation score representing a value resulting from providing the eligible advertisement in response to the advertisement request relative to values of previous advertisement requests for which the eligible advertisement was provided; selecting, as a selected advertisement and by a data processing apparatus, an eligible advertisement to provide in response to the advertisement request, the selected advertisement being an eligible advertisement having an allocation score that meets an allocation score threshold; and providing, by a data processing apparatus, the selected advertisement in response to the request. Other embodiments of this aspect include corresponding systems, apparatus, and computer programs, configured to perform the actions of the methods, encoded on computer storage devices.

These and other embodiments can each optionally include one or more of the following features. A method can further include that action updating the discount factor for the selected advertisement based on the impression score corresponding to the advertisement request. Updating the discount factor can include the actions including the impression score corresponding to advertisement request in the previous impression scores to create updated previous impression scores; and computing an updated discount factor for the selected advertisement, the updated discount factor being computed based on the updated previous impression scores corresponding for the selected advertisement.

Including the impression score corresponding to the advertisement request in the previous impression scores can include the actions determining whether the previous impression scores includes at least a threshold number of previous impression scores; in response to determining that the previous impression scores do not include at least a threshold number of previous impression scores, including the impression score corresponding to the advertisement request in the previous impression scores to create the updated previous impression scores, the impression score being included without removing any of the previous impression scores; in response to determining that the previous impression scores do include at least a threshold number of previous impression scores, replacing a lowest previous impression score with the impression score corresponding to the advertisement request to create the updated previous impression scores.

Computing a discount factor for the eligible advertisement can include the action computing the discount factor based on a function of exponentially weighted impression scores that correspond to previous impression scores for previous advertisement requests for which the eligible advertisement was provided, each previous impression score being exponentially weighted according a sort position corresponding to the impression score.

Computing a discount factor for the eligible advertisement can include the action computing the discount factor based on a function of exponentially weighted impression scores that correspond to previous impression scores for previous advertisement requests for which the eligible advertisement was provided, each previous impression score being exponentially weighted according a sort position corresponding to the impression score, and each impression score being sorted in non-increasing order of impression score and such that a highest impression score is in a first sort position.

In general, another aspect of the subject matter described in this specification can be embodied in methods that include the actions of receiving, by a data processing apparatus, a resource request requesting a resource be allocated in response to the request; identifying available resources that are available to allocate in response to the resource request; for each of the available resources, receiving a request score corresponding to the resource request, the request score representing a value resulting from providing the available resource in response to the resource request irrespective of values of previous resource requests for which the available resource was provided; for each of the available resources, receiving a discount factor for the available resource, the discount factor being computed based on a function of weighted request scores corresponding to previous request scores for previous resource requests for which the available resource was provided, the weighted request scores being assigned weights that are inversely proportional to the previous request scores; for each of the available resources, computing, by a data processing apparatus, an allocation score for the available resource, the allocation score being computed as a function of the request score corresponding to the resource request and the discount factor for the available resource, the allocation score representing a value resulting from allocation of the available resource in response to the resource request relative to values of previous resource requests for which the available resource was provided; selecting, as a selected resource and by a data processing apparatus, an available resource to allocate in response to the resource request, the selected resource being an available resource having an allocation score that meets an allocation score threshold; allocating, by a data processing apparatus, the selected resource in response to the request.

In general, another aspect of the subject matter described in this specification can be embodied in methods that include the actions of receiving, by a data processing apparatus, an advertisement request requesting an advertisement be provided in response to the advertisement request; identifying eligible advertisements that are eligible to be provided in response to the advertisement request; for each of the eligible advertisements: receiving an impression score corresponding to the advertisement request, the impression score representing a value resulting from providing the eligible advertisement in response to the advertisement request irrespective of values of previous advertisement requests for which the eligible advertisement was provided; computing a discount factor for the eligible advertisement, the discount factor being computed as an average of previous impression scores for previous advertisement requests for which the eligible advertisement was provided; computing, by a data processing apparatus, an allocation score for the eligible advertisement, the allocation score being computed as a function of the impression score corresponding to the advertisement request and the discount factor for the eligible advertisement, the allocation score representing a value resulting from providing the eligible advertisement in response to the advertisement request relative to values of previous advertisement requests for which the eligible advertisement was provided; selecting, as a selected advertisement and by a data processing apparatus, an eligible advertisement to provide in response to the advertisement request, the selected advertisement being an eligible advertisement having an allocation score that meets an allocation score threshold; and providing, by a data processing apparatus, the selected advertisement in response to the request.

Particular embodiments of the subject matter described in this specification can be implemented so as to realize one or more of the following advantages. The subject matter described herein causes a computer to more accurately select a resource that increases cumulative value provided to resource providers. Additionally, a computer enabled to perform the methods described provides online resource allocation that approaches a theoretical optimal allocation.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which an advertisement management system manages advertising services.

FIG. 2 is a block diagram of an example process flow for allocating impressions to advertisements.

FIG. 3 is a flow chart of an example process of providing advertisements in response to an advertisement request.

FIGS. 4A-4C illustrate resource allocation using an exponential weighting function.

FIG. 5 is block diagram of an example computer system that can be used to allocate resources in response to resource requests.

Like reference numbers and designations in the various drawings indicate like elements.

### DETAILED DESCRIPTION

Available resources are selected to be provided in response to resource requests based on an analysis of the value of the resource request to providers of the available resources relative to values of previous resource requests for which the available resources have previously been provided. Each presentation of a resource can provide value to the resource provider that provided the resource. Therefore, the cumulative value to the resource provider over a specified period can be computed based on the cumulative value of the presentations of the resource over the specified period. For example, when the specified period is defined by a specified number of presentations of the resource, the cumulative value to the resource provider can be computed based on the cumulative value of the specified number of presentations.

When the number of available presentations available match the specified number of presentations, the cumulative value to the resource provider is increased by increasing the value of one or more of the specified presentations. However, when the number of available presentations is greater than the specified number of presentations, the cumulative value to the resource provider can be increased by replacing one of the specified number of presentations that has been previously allocated to the resource with a more valuable presentation. For example, assuming that a resource is promised 10 presentations, when an 11^{th} presentation is available that has a higher value than any of the previous 10 presentations, the value to the resource provider for 10 presentations can be increased by allocating the 11^{th} presentation to the resource and removing, from the previous 10 presentations, the presentation having the lowest value.

When the cumulative value for a single resource provider is being considered, available presentations that are more valuable to the resource provider than the previously allocated presentations can continue to be allocated to the resource provider to increase the value to the resource provider. However, when the cumulative value being provided to multiple resource providers is being considered, a determination must be made as to which resource provider should be allocated presentations. In some implementations, the determination is made based on which resource provider will receive a largest incremental value from being allocated the presentation.

Throughout this document, selection of a resource for presentation in response to a resource request is interchangeably referred to as allocation of an impression to the selected advertisement. The value of a particular resource request to a resource provider corresponds to the value to the resource provider of the presentation of the resource to a user in response to the resource request. For example, assume each resource request corresponds to a user impression that the resource receives if the resource is provided for presentation in response to the request. Thus, each resource request represents a corresponding impression that is being allocated to an advertisement that is selected to be provided in response to the resource request.

As described in more detail below, a resource is any data that can be provided over the network. The processes described below are illustratively applied to resources that are advertisements provided in response to resource requests requesting advertisements (“advertisement requests”), but the processes also applicable to other resources provided over a network. Additionally, the description that follows describes the advertisements being provided by an allocation subsystem that is implemented as an element of an advertisement management system. However, the allocation subsystem can be implemented as an independent system that communicates directly, or over a network, with the advertisement management system or another data processing apparatus.

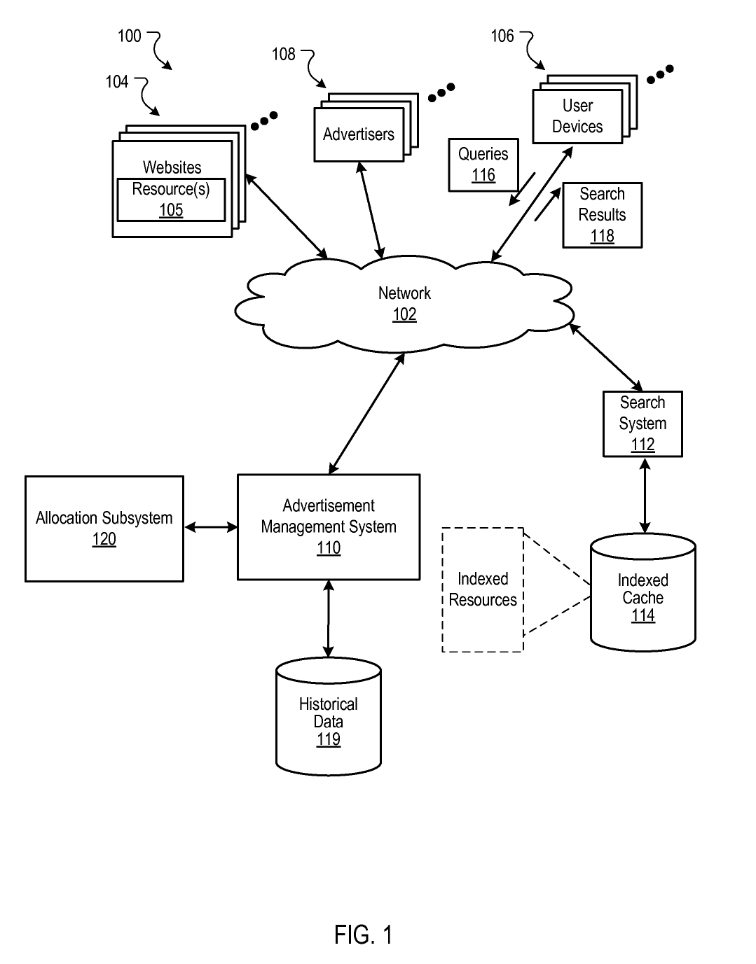

FIG. 1 is a block diagram of an example environment 100 in which an advertisement management system 110 manages advertising services. The example environment 100 includes a network 102 such as a local area network (LAN), wide area network (WAN), the Internet, or a combination thereof. The network 102 connects websites 104, user devices 106, advertisers 108, and the advertisement management system 110. The example environment 100 may include many thousands of websites 104, user devices 106, and advertisers 108.

A website 104 is one or more resources 105 associated with a domain name and hosted by one or more servers. An example website is a collection of webpages formatted in hypertext markup language (HTML) that can contain text, images, multimedia content, and programming elements, e.g., scripts. Each website 104 is maintained by a publisher, e.g., an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few. The resources can include content, e.g., words, phrases, images and sounds that may include embedded information (such as meta-information in hyperlinks) and/or embedded instructions (such as JavaScript scripts).

A user device 106 is an electronic device that is under control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display (e.g., a presentation location of a pop-up window or in a slot of a web page) in which advertisements can be presented. These specified portions of the resource or user display are referred to as advertisement slots.

To facilitate searching of these resources, the environment can include a search system 112 that identifies the resources by crawling and indexing the resources provided by the publishers on the websites 104. Data about the resources can be indexed based on the resource to which the data corresponds. The indexed and, optionally, cached copies of the resources are stored in an indexed cache 114.

User devices 106 can submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. An example search result 118 can include a web page title, a snippet of text or a portion of an image extracted from the web page, and the URL of the web page. Search results pages can also include one or more advertisement slots in which advertisements can be presented.

When a resource 105 or search results 118 are requested by a user device 106, the advertisement management system 110 receives a request for advertisements to be provided with the resource 105 or search results 118. The request for advertisements can include characteristics of the advertisement slots that are defined for the requested resource or search results page, and these requests are provided to the advertisement management system 110.

For example, a reference (e.g., URL) to the resource for which the advertisement slot is defined, a size of the advertisement slot, and/or media types that are available for presentation in the advertisement slot can be provided to the advertisement management system 110. Similarly, keywords associated with a requested resource (“resource keywords”) or a search query 116 for which search results are requested can also be provided to the advertisement management system 110 to facilitate identification of advertisements that are relevant to the resource or search query 116.

Based on data included in the request for advertisements, the advertisement management system 110 can select advertisements that are eligible to be provided in response to the request (“eligible advertisements”). For example, eligible advertisements can include advertisements having characteristics matching the characteristics of advertisement slots and that are identified as relevant to specified resource keywords or search queries 116. In some implementations, advertisements having targeting keywords that match the resource keywords or the search query 116 are selected as eligible advertisements by the advertisement management system 110.

A targeting keyword can match a resource keyword or a search query 116 by having the same textual content (“text”) as the resource keyword or search query 116. For example, an advertisement associated with the targeting keyword “hockey” can be an eligible advertisement for an advertisement request including the resource keyword “hockey.” Similarly, the advertisement can be selected as an eligible advertisement for an advertisement request including the search query “hockey.”

A targeting keyword can also match a resource keyword or a search query 116 by having text that is identified as being relevant to a targeting keyword or search query 116 despite having different text than the targeting keyword. For example, an advertisement having the targeting keyword “hockey” may also be selected as an eligible advertisement for an advertisement request including a resource keyword or search query for “sports” because hockey is a type of sport, and therefore, is relevant to the term “hockey.”

The advertisement management system 110 can select the eligible advertisements that are provided for presentation in advertisement slots of a resource or search results page based on results of an auction. For example, the advertisement management system 110 can receive bids from advertisers and allocate the advertisement slots to the highest bidders at the conclusion of the auction. The bids are amounts that the advertisers are willing to pay for presentation (or selection) of their advertisement with a resource or search results page. For example, a bid can specify an amount that an advertiser is willing to pay for each 1000 impressions (i.e., presentations) of the advertisement, referred to as a CPM bid. Alternatively, the bid can specify an amount that the advertiser is willing to pay for a selection (i.e., a click-through) of the advertisement or a “conversion” following selection of the advertisement. The highest bidders can be determined based on the bids alone, or based on the bids of each bidder being multiplied by one or more factors, such as quality scores derived from advertisement performance, landing page scores, and the like.

A conversion occurs when a user performs a particular action related to an advertisement provided with a resource or search results page. What constitutes a conversion may vary from case to case and can be determined in a variety of ways. For example, a conversion may occur when a user clicks on an advertisement, is referred to a web page, and consummates a purchase there before leaving that web page. A conversion can also be defined by an advertiser to be any measurable/observable user action such as, for example, downloading a white paper, navigating to at least a given depth of a website, viewing at least a certain number of web pages, spending at least a predetermined amount of time on a website or web page, registering on a website, etc. Other actions that constitute a conversion can also be used

The number of impressions that a particular advertiser receive will vary based, in part, on actions of other advertisers. For example, other advertisers in the auction may increase their bids to values higher than that of the particular advertiser. In turn, advertisements provided by the other advertisers may be presented in the advertisements slots that are allocated through the auction. Thus, the number of impressions that the particular advertiser's advertisement(s) receives may be below a number of impressions that the particular advertiser desired. The particular advertiser may have to increase its bid, and potentially pay more money than originally budgeted, to receive the desired number of impressions.

Some advertisers prefer that the number of impressions allocated to their advertisement and the price paid for the number of impressions be more predictable than the predictability provided by an auction. An advertiser can increase the likelihood that its advertisement receives a desired or specified number of impressions, for example, by entering into an agreement with a publisher, where the agreement requires the publisher to provide at least a threshold number of impressions (e.g., 1,000 impressions) for the advertisement over a specified period (e.g., one week). In turn, the advertiser, publisher, or both parties can provide data to the advertisement management system 110 that enables the advertisement management system 110 to facilitate satisfaction of the agreement.

For example, the advertiser can upload an advertisement and authorize the advertisement management system 110 to provide the advertisement in response to advertisement requests corresponding to the publisher's website. Similarly, the publisher can provide the advertisement management system 110 with data representing the specified time period as well as the threshold number of impressions that the publisher has agreed to allocate to the advertisement over the specified time period.

To facilitate allocation of advertisements according to the terms of an agreement between two parties, the advertisement management system 110 includes an allocation subsystem 120. The allocation subsystem 120 selects eligible advertisements for presentation with a publishers website in accordance with the agreement. The allocation subsystem 120 determines, for example, an expected number of impressions that are available from the publisher's website over the specified time period and allocates impressions to the advertisement(s) such that the threshold number of impressions are allocated to the advertisement(s) by the end of the specified period.

Although the number of impressions that the publisher's website will receive over the specified time period is not known with absolute certainty in advance, the allocation subsystem 120 can compute the expected number of impressions for the website over the specified time period based on historical user impression data that is stored, for example, in a historical data store 119. The historical data store 119 is a data store that stores data representing previous user interactions with publisher websites and advertisements. For example, in response to receiving a request for an advertisement, the advertisement management system 110 can store data identifying the website to which the request corresponds and identifying the request as an impression for the website. Additionally, the advertisement management system 110 can store data representing the advertisements that were provided in response to the request and any user actions (e.g., click-throughs or conversions) that are detected following presentation of the advertisements. Alternatively the publisher can provide these estimates to the advertisement management system 110 for storage in the historical data store 119.

The allocation subsystem 120 receives the user impression data for a website from the historical data store 119 and computes the expected number of impressions based, for example, on a statistical analysis of a total number of impressions for the website over time periods that are similar to the specified time period over which the impressions are to be allocated to the advertisement. The allocation subsystem 120 can also use trending information to adjust the expected number of impressions based on identified trends in user impressions for the website. The expected number of impressions for the website can be provided to the publisher so that the publisher can use the expected number of impressions as a basis for entering agreements with advertisers to provide advertisement impressions. Additionally, the allocation subsystem 120 can use the expected number of user impressions, as described above, to allocate user impressions over the specified period so that the threshold number of impressions are provided to the advertiser over the specified period.

In addition to satisfying the terms of an agreement by providing the advertiser with at least the threshold number of impressions, advertisers and publishers generally prefer impressions to be allocated to advertisements in a manner that provides a higher cumulative value relative to other possible allocations. For example, when the cumulative value to an advertiser increases without an increase in price, the advertiser achieves a higher return on investment. The publisher also prefers that the impressions be allocated to increase the cumulative value to the advertisers because doing so increases advertiser satisfaction with the agreement and makes it more likely that advertisers will continue to enter agreements with the publisher.

The allocation subsystem 120 is configured to allocate impressions to advertisers so that allocation of the impressions increases the cumulative value provided to the advertisers. In some implementations, the allocation subsystem 120 determines, for each of the advertisers, a value of an impression corresponding to an advertisement request based on the characteristics of the impression, and determines the effect that the impression would have on the cumulative value to each advertiser if the impression were allocated to the advertiser. In turn, the allocation subsystem 120 can, in some implementations, allocate the impression to the advertiser whose cumulative value increases the most as a result of the impression being allocated to the advertiser, as described in more detail below. In other implementations, the impression can be allocated to an advertiser whose cumulative value increases, but may not increase the most.

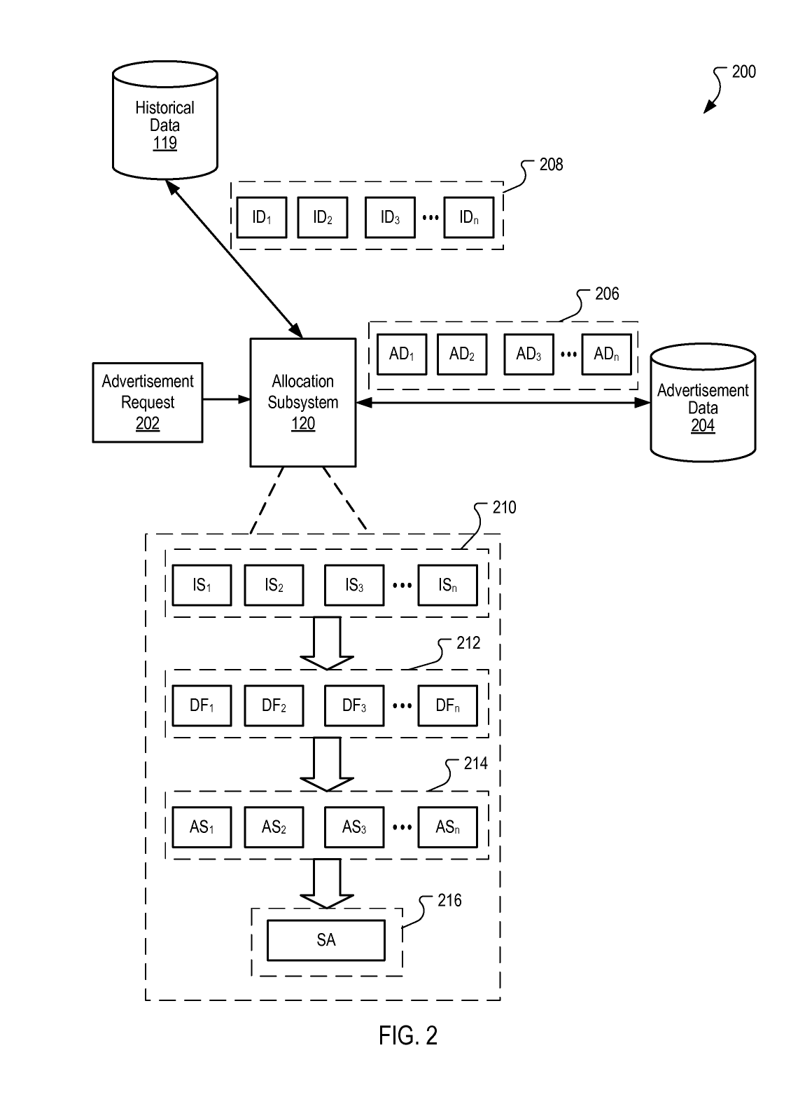

FIG. 2 is a block diagram of an example process flow 200 for allocating impressions to advertisements. The allocation subsystem 120 receives an advertisement request 202 as input. The advertisement request 202 includes data identifying a resource (e.g., web page) that has an available impression, and for which the advertisement request 202 is being submitted. The advertisement request 202 also includes characteristics of the impression that is available for the resource. For example, the advertisement request 202 can include demographic and/or psychographic information about the user to which the advertisement will be presented, a geographic location of the user, user interests, and other targeting criteria corresponding to the impression. Further, the advertisement request can include information about the advertisement slot in which a selected advertisement will be presented (e.g., dimensions and acceptable file formats).

In response to the advertisement request 202, the allocation subsystem 120 requests eligible advertisement data from an advertisement data store 204. The advertisement data store 204 is a data store storing data corresponding to advertisements that are available for presentation. The request from the allocation subsystem 120 may request, for example, data identifying advertisements that are eligible for presentation with the resource, where the advertisements that are eligible for presentation have targeting criteria that match the impression characteristics specified by the advertisement request 202. In some implementations, an advertisement can be eligible for presentation with a particular publisher webpage based solely, or in part, on an agreement that the publisher and an advertiser have entered into, as described above.

In response to the request for eligible advertisement data, a set of eligible advertisement data 206 identifying eligible advertisements (AD1-ADn) is received by the allocation subsystem 120. The eligible advertisements (AD1-ADn) identified by the set of eligible advertisement data 206 can include, for example, advertisements having targeting criteria that match the characteristics of the impression corresponding to the advertisement request 202.

Using the set of eligible advertisement data 206, the allocation subsystem 120 retrieves a set of impression data 208 for the eligible advertisements (AD1-ADn). The set of impression data 208 includes impression data (ID1-IDn) corresponding to each of the eligible advertisements (AD1-ADn). For example, the impression data (e.g., ID1) corresponding to an eligible advertisement (e.g., AD1) can include data representing previous impressions that have been allocated to the eligible advertisement as well as a value of each of the previous impressions to the advertiser that provided the eligible advertisement. When the advertisement request 202 is the first advertisement request being submitted for a particular resource or a new eligible advertisement is identified for the resource, the impression data can have default values (e.g., 0.0) indicating that there have been no previous impressions for the resource and/or advertisement.

The allocation subsystem 120 also uses the set of advertisement data 206 and data included in the advertisement request 202 to obtain a set of impression scores 210 that include impression scores (e.g., IS1-ISn). Each impression score corresponds to an eligible advertisement (e.g., (AD1-ADn) and represents the value of the impression to the advertiser corresponding to the eligible advertisement. For example, the value of the impression to an advertiser corresponding to an eligible advertisement can be computed based on how well targeting criteria for the eligible advertisement matches criteria specified by the advertisement request, a predicted performance measure for the eligible advertisement, or a function provided by the advertiser for computing a value of an impression. The impression scores can be also computed based on historical performance measures for the advertisement when allocated previous impressions having similar characteristics as the current impression being allocated. In some implementations, the impression scores can be received from a data processing apparatus that computes impression scores based on data provided about the eligible advertisement and the impression being allocated.

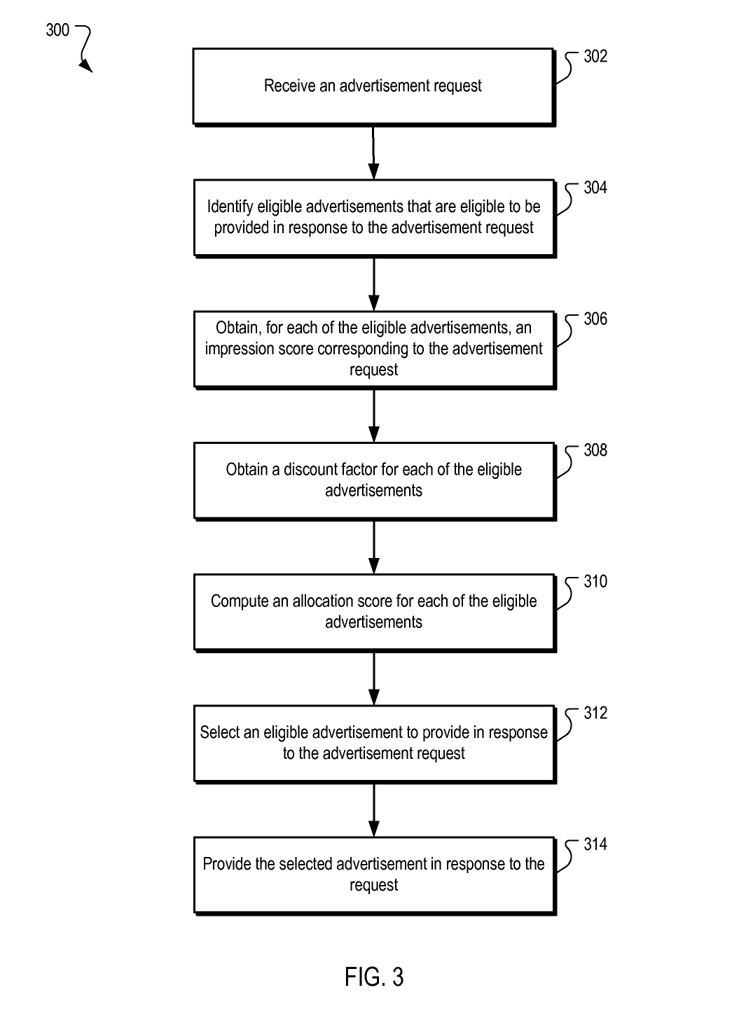

The allocation subsystem 120 also receives or computes a set of discount factors 212, where the set includes discount factors (DF1-DFn) that are each computed from the impression scores of impressions that have been previously allocated to corresponding eligible advertisements (AD1-ADn). In some implementations, each discount factor is computed as a function of the impression scores of a threshold number of impressions that have been previously allocated to the advertisement. For example, the discount factor for a particular advertisement can be an average, a weighted sum, or a weighted average of the threshold number of impressions having the highest scores. The threshold number of impressions can be, for example, the number of impressions that the advertiser has purchased from the publisher, or that the publisher has otherwise agreed to allocate to the advertiser. In some implementations, the discount factors (DF1-DFn) can be computed using impression scores that are each weighted based on a exponential weighting methodology that assigns higher weights to lower impression scores than the weights assigned to higher impression scores, as described in more detail with reference to FIG. 3.

Once the set of discount factors 212 has been received or computed, the allocation subsystem 120 can compute a set of allocation scores 214 that includes an allocation score (e.g., AS1-ASn) for each eligible advertisement (AD1-ADn). The allocation score represents a measure of incremental value that results from providing the advertisement in response to an advertisement request (i.e., allocating the impression corresponding to the advertisement request to the advertisement). In some implementations, the allocation subsystem 120 can compute an allocation score, for example, as a mathematical difference between the impression score for each eligible advertisement and the discount factor for the eligible advertisement. Other ways of computing an allocation score can also be used.

Based on the allocation scores (e.g., AS1-ASn), the allocation subsystem 120 can select an eligible advertisement to be provided in response to the advertisement request 202. For example, the allocation subsystem 120 can select, as the selected advertisement 214 to be provided in response to the advertisement request, the eligible advertisement for which the mathematical difference between the impression score and the discount factor is highest. In turn, the allocation subsystem 120 can provide the selected advertisement 214 in response to the advertisement request 202.

After each selection of an advertisement, the corresponding impression data ID for that advertisement is updated. For example, data identifying the impression for which the advertisement was provided as well as the advertiser's impression score IS for the impression can be stored in a data store. Thereafter, the corresponding discount factors DF, and allocation scores AS for that advertisement for the next advertisement are computed based on the updated impression data.

FIG. 3 is a flow chart of an example process 300 of providing advertisements in response to an advertisement request. According to the process 300, an advertisement request is received and eligible advertisements that are eligible to be provided in response to the request are identified. For each of the eligible advertisements, an impression score corresponding to the advertisement request and a discount factor are obtained. Using the impression scores and the discount factors, an allocation score is computed for each of the advertisements. Based on the allocation scores, an eligible advertisement is selected and provided in response to the advertisement request.

The process 300 can be implemented, for example, by the allocation subsystem 120 and/or the advertisement management system of FIG. 1 having access to the impression data. In some implementations, the allocation subsystem 120 is a data processing apparatus that includes one or more processors that are configured to perform actions of the process 300. In other implementations, a computer readable medium can include instructions that when executed by a computer cause the computer to perform actions of the process 300.

An advertisement request is received (302). In some implementations, the advertisement request is a request for an advertisement to be provided with a publisher's resource. For example, the advertisement request can be a request for an advertisement to be provided in a particular advertisement slot that is defined in the publisher's webpage or an advertisement slot that is defined to be presented with the publisher's webpage.

The advertisement request can include data identifying a resource (e.g., web page) that has an available impression, and for which the advertisement request 202 is being submitted. The advertisement request can further include data identifying characteristics of the advertisement slot in which the requested advertisement will be presented as well as characteristics of the impression corresponding to the advertisement request. For example, the advertisement request can include physical characteristics of the advertisement slot (e.g., size, shape, and location), characteristics of a user that will be presented the advertisement slot (e.g., demographic and psychographic information), as well as characteristics of the content that will be presented with the advertisement (e.g., resource keywords that represent topics to which the content is relevant).

In response to the advertisement request, eligible advertisements that are eligible to be provided in response to the advertisement request are identified (304). In some implementations, the eligible advertisements are advertisements for which the publisher of the resource for which the advertisement request is being submitted has agreed to allocate impressions. As described above with reference to FIG. 1, a publisher can agree to allocate at least a threshold number of impressions to one or more advertisers' advertisements. In turn, the details of the agreement can be provided to an advertisement management system that manages allocation of impressions to advertisements. Thus, when an advertisement request identifies the publisher's site, the advertisements to which the publisher has agreed to allocate impressions can be identified as the eligible advertisements.

In some implementations, the eligible advertisements for a particular advertisement request are a subset of the advertisements to which the publisher has agreed to allocate impressions. For example, if a publisher has agreed to allocate to example advertisement A impressions only on pages that include sports content, advertisement A will not be an eligible advertisement for an advertisement request corresponding to a political page provided by the publisher that does not include sports content. Similarly, an advertiser can specify targeting criteria (e.g., targeting keywords and user age) that must be met for the advertisement to be an eligible advertisement. In this situation, the advertiser's advertisement is an eligible advertisement only for those advertisement requests corresponding to impressions that match the targeting criteria.

In some implementations, the eligible advertisements can include advertisements for which the publisher has already provided the number of impressions that the publisher agreed to provide. For example, assuming that a publisher has agreed to allocate 100 impressions to advertisement X and 500 impressions to advertisement Y, and 100 impressions have already been allocated to each advertisement, both of the advertisements can remain eligible advertisements for advertisement requests corresponding to the publisher's pages. As described in more detail below, allowing an advertisement (e.g., advertisement X) to continue to be an eligible advertisement even after an agreed upon number of impressions (e.g., 100 impressions) have been allocated to the advertisement enables the value of the agreed upon number of impressions (e.g., a top 100 impression values) to be increased beyond the value of an initially allocated agreed upon number of impressions (e.g., the initial 100 impressions that are allocated to advertisement X).

For each of the eligible advertisements, an impression score corresponding to the advertisement request is received (306). In some implementations, the impression score represents a value from providing the eligible advertisement in response to the advertisement request. The value to the advertiser from providing the eligible advertisement can be determined irrespective of whether the eligible advertisement has been allocated any other impressions or the values (e.g., impression scores) of any previous advertisement requests for which the eligible advertisement was provided. Impression scores for the advertisement request can be received, for example, from a data store storing impression scores indexed by advertisement (or advertiser) and impression characteristics specified by the advertisement request, computed based on a functions provided by the advertisers, or computed based on predicted performance measures of the eligible advertisements if the eligible advertisements were to be provided in response to the advertisement request.

In some implementations, the impression score for each advertisement can be computed based on an estimated click-through rate or conversion rate for the advertisement if the advertisement were provided in response to the advertisement request. For example, using historical advertisement selection data and/or conversion data, a baseline advertisement performance (e.g., average, median, or other statistical measure of performance) for advertisements presented in response to previous instances of the advertisement request can be computed. This baseline advertisement performance can then be adjusted based on how well the advertisement's targeting criteria is matched by the advertisement request and/or previous performance data for the advertisement when provided in response to advertisement requests having similar characteristics. In turn, the estimated performance for the advertisement can be assigned as the impression score or converted/normalized to an impression score that represents the value of the impression, for example, on a normalized scale (e.g., on a scale from 1-10).

In other implementations, the impression score can be computed based on values that are received for each advertisement. Data may be received from advertisers specifying various values corresponding to different impressions having differing characteristics. For example, an advertiser may specify that the advertiser receives $1.00 of value from each presentation of an advertisement to users between the ages of 18-25, while only deriving $0.50 of value from each presentation of the advertisement to users that are 26-30. Values can similarly be received from other advertisers and for other impression characteristics. The values received from the advertisers can be stored in data store and retrieved, for example, based on impression characteristics specified by an advertisement request.

A discount factor is obtained for each of the eligible advertisements (308). The discount factor represents an aggregate value of previous impressions that have been allocated to an advertisement. The discount factor can be used, for example, to discount (e.g., reduce or adjust) the impression score of an advertisement request to obtain an allocation score for the advertisement, as described in more detail below. In some implementations, the discount factor is computed based on a function of impression scores corresponding to previous advertisement requests for which the eligible advertisement was provided (i.e., previous impressions that were allocated to the eligible advertisement).

In some implementations, the discount factor for each advertisement can be computed based on previous impression scores of all previous impressions that have been allocated to the advertisement, irrespective of a number of impressions that the publisher agreed to provide the advertisement. In other implementations, the discount factor for each advertisement is computed based on previous impression scores of a threshold number of previous impressions that have been allocated to the advertisement.

The threshold number of previous impressions can be specified on a per-advertisement basis such that the discount factor for each advertisement can be computed based on a different threshold number of previous impressions. In some implementations, the threshold number of previous impressions for a particular advertisement can be, for example, the number of impressions that a publisher agreed to provide for the advertisement. In these implementations, when an advertisement has not been provided the agreed upon number of advertisements, every impression provided to the advertisement can be used to compute the discount factor for the advertisement. Once the advertisement has been provided the agreed upon number of advertisements, the discount factor is computed based on the agreed upon number of advertisements that have the highest impression scores.

For example, assuming again that a publisher agreed to allocate 100 impressions to advertisement X and 500 impressions to advertisement Y. Now assume that each advertisements has been allocated 200 impressions. In this example, the discount factor for advertisement Y is computed based on all 200 impressions that have been allocated to advertisement Y because the agreed upon 500 impressions have yet to be allocated to advertisement Y. However, because the publisher agreed to provide 100 impressions to advertisement X, the discount factor for advertisement X is computed using the 100 impressions having the highest 100 impression scores from among the 200 impressions that have been allocated to advertisement X.

Prior to being allocated any impressions, the discount factor for an advertisement can be set to an initial value or default value. For example, in some implementations, the discount factor for an advertisement that has not yet been allocated an impression can be set to zero. Upon being allocated a first impression, the discount factor for the advertisement can be updated by computing the discount factor using the impression score of that first impression. The discount factor can continue to be iteratively updated by computing a new discount factor using the impression scores of the impressions that the advertisement was allocated.

In subsequent iterations the discount factor can be updated based on updated previous impression scores. In some implementations, the updated previous impression scores can be iteratively updated to include the most recent impression score for which the advertisement was provided. In these implementation, the impression score for the most recent impression is simply added to the previous impression scores, or one of the previous impression scores may need to be removed in order to include the impression score of the most recent impression score.

In these implementations, the allocation subsystem 120 determines whether the previous impression scores include at least a threshold number of previous impression scores. For example, the number of previous impression scores that are stored for the advertisement can be compared to the total number of impressions that the publisher has agreed to allocated to the advertisement. In response to determining that there are not a threshold number of previous impression scores (i.e., the previous impression scores used to compute the discount factor do not include at least a threshold number of previous impression scores), the impression score for the most recent impression can be added to the previous impression scores to create a set of updated previous impression scores. Thus, in this scenario, the impression score for the most recent impression is included without removing any of the previous impression scores.

However, if there are at least the threshold number of previous impression scores stored for the advertisement, then one of the previous impression scores may need to be removed to include the impression score for the most recent impression. For example, a lowest previous impression score among the previous impression scores can be replaced with the impression score corresponding to the most recent impression.

In some implementations, the discount factor for an advertisement is computed as a ratio of the sum of the impression values relative to the number of impressions that a publisher has agreed to allocate the advertisement, as represented by relationship (1)

$$DF = \frac{{\sum }_{i = 1}^{n} {IS}_{i}}{{I}_{A}} \qquad ( 1 )$$

Where,
DF is the discount factor;
ISᵢ is the impression score of impression(i);
I_{A} is the agreed upon number of impressions to be allocated to the advertisement; and

n is the number of impression scores being used to compute the discount factor, where 1≦n≦I_{A}.

Thus, according to relationship (1), when the total number impressions allocated to the advertisement equals the agreed upon number of impression to be allocated (i.e., the threshold number of impressions), the discount factor is an average impression score for each of the impressions. However, when the number of impressions allocated to the advertisement is lower than the agreed upon number of impressions, the discount factor is a ratio of the sum of the impression values relative to the agreed upon number of impressions. When the number of impressions allocated to the advertisement exceeds the agreed upon number of impressions, the discount factor for the advertisement can be the average of the highest I_{A} impression values.

In addition to computing the discount factor as described above, the discount factor can be assigned the value of the lowest impression score for a highest agreed upon number of impressions. For example, assuming that a publisher has agreed to provide 100 impressions to an advertisement and at least 100 impressions have been allocated to the advertisement, the discount factor for the advertisement can be set to the value of the 100^{th} highest impression score among the impression that have been allocated to the advertisement. When fewer than the agreed upon number of impressions have been allocated to the advertisement, the discount factor for the advertisement can be set to a default value (e.g., 0.0).

The discount factor can also be computed as a result of an exponential weighting function that provides an initial weight to a highest impression score and exponentially increasing weights to each subsequent lower impression score. An example, function that can be used to compute a discount factor using exponential weighting is provided by relationship (2).

$$DF = NF * {\sum }_{i = 1}^{IA} {{IS}_{i} ( 1 + \frac{1}{{I}_{A}} )}^{i - 1} \qquad ( 2 )$$

Where,
DF is the discount factor;
NF is a normalization factor (e.g., 1/(I_{A}((1+1/I_{A})̂I_{A})−1));
I_{A} is the agreed upon number of impressions; and
ISᵢ is the impression score of impression(i), where the impression scores are sorted in non-increasing order of impression score from i=1 to i=I_{A}.

Thus, according to relationship (2), each impression score is weighted by an exponential of 1+1/I_{A} according to a sort position of the impression score. For example, the highest impression score is in the first sort position (i.e., i=1), such that impression score(1) is weighted by a factor of 1 (i.e., 1+1/I_{A})⁰). The second highest impression score is in the second sort position (i.e., i=2), such that impression score (2) is weighted by a factor of 1+1/IA (i.e., 1+1/IA)¹. Each lower impression value is similarly weighted by increasing exponential factors of 1+1/I_{A}. Weighting the impression scores according to an exponential weighting function, such as that provided by relationship (2) assigns the highest weight to the lowest impression score among the highest I_{A} impression scores.

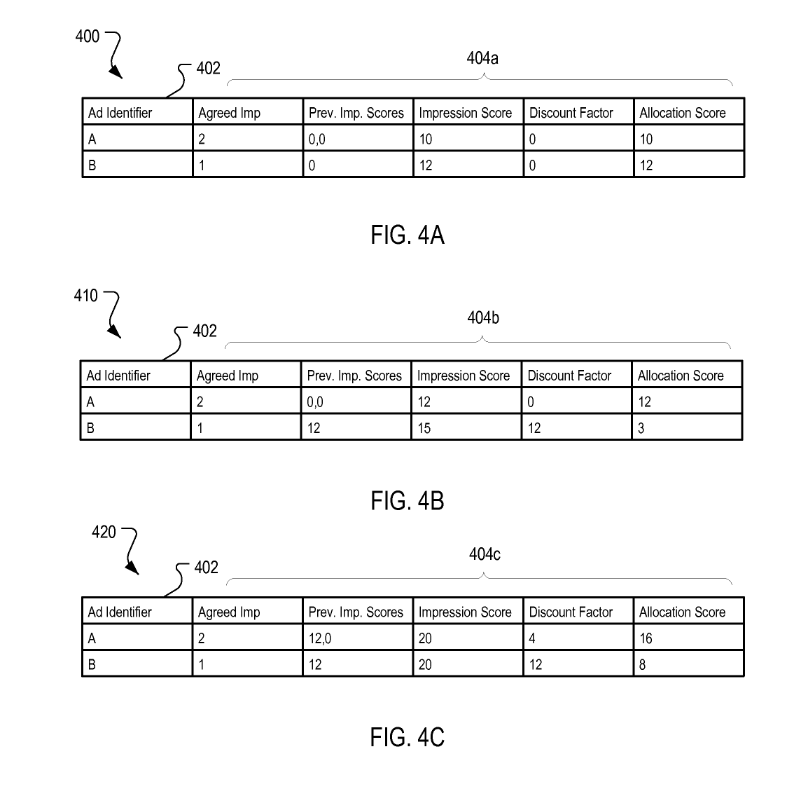

While relationship (2) is provided for purposes of example, other exponential weighting functions can be used. As described in more detail with reference to an example allocation process presented in FIG. 4, weighting the impression scores in this manner facilitates allocation of impressions in manner that approaches a maximum obtainable impression value for the advertisers. Additionally, other non-exponential functions can also be used.

An allocation score is computed for each of the eligible advertisements (310). The allocation score for an advertisement represents a measure of incremental value that results from providing the advertisement in response to an advertisement request (i.e., allocating the impression corresponding to the advertisement request to the advertisement). For example, a higher incremental value is achieved by allocating an impression to an advertisement having a higher allocation score than the incremental value achieved by allocating the impression to an advertisement having a lower allocation score.

The allocation score for each eligible advertisement is computed as a function of the impression score received for the advertisement and the discount factor obtained for the advertisement. For example, the allocation score for a particular advertisement can be a mathematical difference between the impression value and the discount factor. Other functions can be used to compute the allocation score. For example, an allocation score may be computed as a ratio of the impression score to the discount factor.

Using the allocation scores, an eligible advertisement is selected to provide in response to the advertisement request (312). In some implementations, the selected advertisement is the eligible advertisement having a highest allocation score. In other implementations, the selected advertisement can be an eligible advertisement having an allocation score that satisfies an allocation score threshold. For example, the allocation score threshold operate as a condition that an advertisement must meet in order for the advertisement to be selected for presentation. When a threshold allocation score is used as a condition for selecting advertisements, the advertisement that is selected for presentation can be selected for example based on relevance scores for the advertisements, where the relevance scores are a measure of relevance between the advertisements and the publisher resource with which the advertisement will be presented.

The selected advertisement is provided in response to the request (314). In some implementations, the selected advertisement can be provided to a user device that requested the publisher resource with which the advertisement is being provided. The advertisement can be provided to the user device, for example, over a content delivery network. The advertisement can be provided with presentation instructions that specify an advertisement slot in which the advertisement is to be presented. In turn, the advertisement can be presented on a user device according to the presentation instructions.

The process 300 can be iteratively performed for a single publisher resource and multiple instances of the process 300 can be performed in parallel by one or more data processing apparatus. For example, the process 300 can be performed in parallel for two or more different resource requests that are received requesting allocations of resources.

FIGS. 4A-4C illustrate resource allocation using an exponential weighting function. The resource allocation illustrated by FIGS. 4A-4C can be implemented, for example, using the process 300 and by the allocation subsystem 120 of FIG. 1. In some implementations, the resources allocated are advertisements. In other implementations, the resources allocated can be video files, audio files, or other content that can be distributed over a content delivery network in response to a request. The example, below is described with reference allocating advertisements.

FIG. 4A is table 400 that is populated by a set of advertisement identifiers 402 and corresponding data 404a for the advertisements corresponding to the advertisement identifiers. The data 404a includes data representing the number of impressions that a publisher has agreed to provide each of the advertisements, a set of previous impression scores for previous impressions that were allocated to the advertisements, an impression score corresponding to a current resource request, the discount factor for the advertisement, and the allocation score for the advertisement. In this example, the discount factor is computed according to relationship (2), the allocation score is computed as a mathematical difference between the impression score and the discount factor, and an impression is allocated to the advertisement having the highest allocation score.

Table 400 provides example data 404a for the advertisement identifiers upon receipt of a first resource request. For example, when a first resource request is received, the previous impression scores and discount factor can each have default values of 0.0. Therefore, the allocation scores for the advertisements will be equal to their respective impression scores for the first resource request. In this example, the impression corresponding to the first resource request is allocated to advertisement B because its allocation score for the first resource request is 12, while the allocation score of advertisement A is 10. This, advertisement B is provided in response to the first resource request.

Once an advertisement has been provided in response to the first resource request, the discount factors for the advertisements can be updated. For example, the discount factor for advertisement B can be computed according to relationship (2) based on the impression score of the first resource request. Because advertisement A was not provided in response to the resource request, its discount factor remains unchanged.

The updated discount factors can be stored in a data store, such as the historical data store 119 of FIG. 1. The impression score corresponding to the selected advertisement can also be stored in the historical data store 119. In some implementations, the updated discount factors and the impression score corresponding to the selected advertisement can be stored in the data store as impression data that is available for use in selecting advertisements for presentation in response to future resource requests.

Table 410 of FIG. 4B provides example data 404b that includes the updated discount factor for the advertisements, updated previous impression scores, and new impression scores for a second resource request. When determining the allocation scores for the advertisements for the second resource request, the discount factor of advertisement B is non-zero, such that the allocation score for advertisement B will be the mathematical difference between its impression score and its discount score. In this example, the advertisement B has an impression score of 15 for the second resource request, but its discount factor is 12. Therefore, the allocation score for advertisement B is 3 (i.e., 15-12=3). However, because advertisement A has yet to be provided in response to a resource request, its discount factor is still 0. Therefore, the allocation score for advertisement A is equal to 12, its impression score for the second resource request. Therefore, advertisement A has the higher allocation score for the second resource request and is provided in response the second resource request. Following the determination that advertisement A is to be provided in response to the second resource request, the discount factor of advertisement A is updated.

Table 420 of FIG. 4C provides example data 404c that includes the updated discount factor for advertisement A. As provided by chart 420, even though advertisement A and advertisement B both have one previous impression score of 12, the discount factor for advertisement B is 12, while the discount factor for advertisement A is 4. The difference in discount factors is due to the fact that the publisher agreed to provide advertisement A two impressions, while only agreeing to provide advertisement B 1 impression. Therefore, according to relationship (2), the discount factor for advertisement A is computed based on an AI of 2, while the discount factor for advertisement B is computed based on an AI of 1.

Table 420 also includes updated previous impression scores for advertisement A and the impression scores corresponding to a third resource request as well as a newly computed allocation score for each of the advertisements. According to chart 420, the impression scores for advertisements A and B are each 20. Using the respective discount factors of the advertisements, the allocation score for advertisement A is 16, while the allocation score for advertisement B is 8. Therefore, advertisement A is selected to be provided in response to the third resource request.

Advertisements A and B can continue to be provided in response to resource requests based on their respective allocation scores and have their discount factors updated. In some implementations, when a resource request is received that results in negative allocation scores for each of the advertisements, the resource request can be ignored because allocating either of the advertisements will not provide incremental value. In other implementations, the impression corresponding to the resource request can be allocated to the advertisement having the least negative allocation score, or based on a pseudo-random selection of the eligible advertisements.

Allocating impressions to advertisements as describe with reference to FIGS. 3 and 4A-4C results in an allocation that approaches a theoretical optimal allocation. For example, allocating impressions as described above can approach a competitive ratio of 1−1/e as the number of agreed upon impressions increases to a sufficient level. The competitive ratio is measure of value obtained by an allocation relative to the optimum value that can be obtained using the set of impressions.

The impression allocation techniques described above can be implemented in an “online” process that receives resource requests, identifies eligible advertisements, and selects an eligible advertisement to be provided by a near real-time process that operates within time constraints for providing advertisements.

The allocation techniques described above can be generalized to optimize resource allocation based on any resource constraint. For example, in some implementations, the allocation techniques described above can be applied to optimize a total amount of screen display that is allocated to resources or to optimize a performance metric (e.g., click-through-rate) of the resources. In these implementations, instead of allocating a single resource in response to a single resource request, a portion of available resource capacity is allocated in response to a request for the portion of the available resource.

For example, assume that instead of an agreed upon number of impressions, a publisher agreed to present at least an agreed upon number of advertisement pixels to an advertisement. In this situation, the advertisement can occupy from 1 pixel to a number of available pixels on the display by changing the resolution of the advertisement. Thus, each request can specify an advertisement size and the selected advertisement can be the advertisement for which the allocation score is maximized by the request.

The techniques described above can also apply to machine scheduling problems where the processing time required to complete a job request is a resource request and the value of assigning the job to each available machine corresponds to the impression value described above.

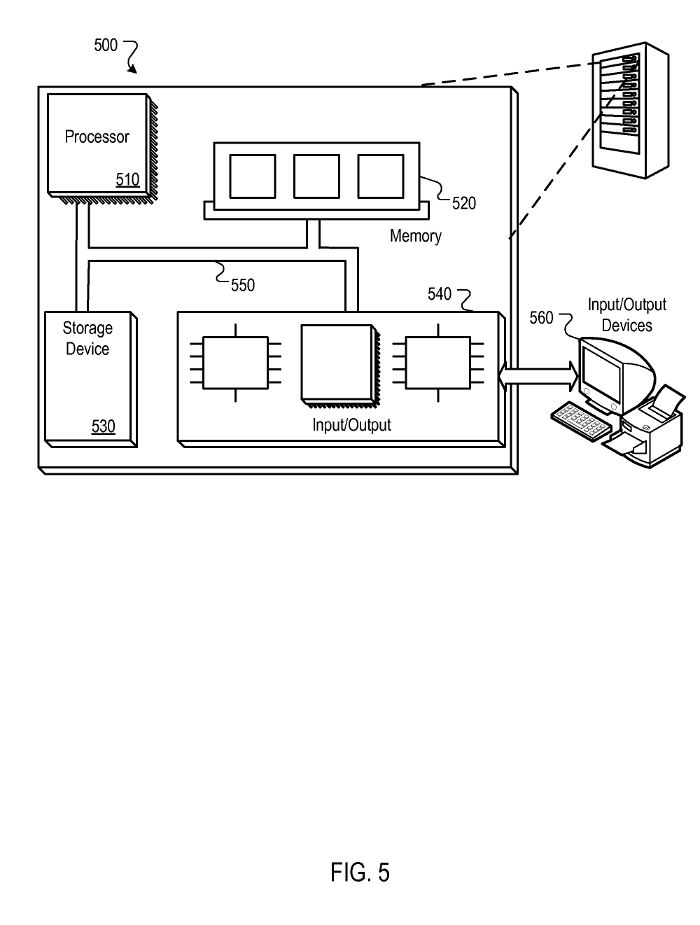

FIG. 5 is block diagram of an example computer system 500 that can be used to allocate resources in response to resource requests. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 860. Other implementations, however, can also be used, such as mobile computing devices, mobile communication devices, set-top box television client devices, etc.

The allocation subsystem 120 and/or advertisement management system 110 can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The allocation subsystem 120 and/or advertisement management system 110 can be distributively implemented over a network, such as a server farm, or can be implemented in a single computer device.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving, by a data processing apparatus, an advertisement request requesting an advertisement be provided in response to the advertisement request;
identifying eligible advertisements that are eligible to be provided in response to the advertisement request;
for each of the eligible advertisements:
receiving an impression score corresponding to the advertisement request, the impression score representing a value resulting from providing the eligible advertisement in response to the advertisement request irrespective of values of previous advertisement requests for which the eligible advertisement was provided;
computing a discount factor for the eligible advertisement, the discount factor being computed based on a function of weighted impression scores corresponding to previous impression scores for previous advertisement requests for which the eligible advertisement was provided, the weighted impression scores being assigned weights that are inversely proportional to the previous impression scores;
computing, by a data processing apparatus, an allocation score for the eligible advertisement, the allocation score being computed as a function of the impression score corresponding to the advertisement request and the discount factor for the eligible advertisement, the allocation score representing a value resulting from providing the eligible advertisement in response to the advertisement request relative to values of previous advertisement requests for which the eligible advertisement was provided;
selecting, as a selected advertisement and by a data processing apparatus, an eligible advertisement to provide in response to the advertisement request, the selected advertisement being an eligible advertisement having an allocation score that meets an allocation score threshold; and
providing, by a data processing apparatus, the selected advertisement in response to the request.

2. The method of claim 1, further comprising, updating the discount factor for the selected advertisement based on the impression score corresponding to the advertisement request.

3. The method of claim 2, wherein updating the discount factor comprises:
including the impression score corresponding to advertisement request in the previous impression scores to create updated previous impression scores; and
computing an updated discount factor for the selected advertisement, the updated discount factor being computed based on the updated previous impression scores corresponding for the selected advertisement.

4. The method of claim 3, wherein including the impression score corresponding to the advertisement request in the previous impression scores comprises:
determining whether the previous impression scores includes at least a threshold number of previous impression scores;
in response to determining that the previous impression scores do not include at least a threshold number of previous impression scores, including the impression score corresponding to the advertisement request in the previous impression scores to create the updated previous impression scores, the impression score being included without removing any of the previous impression scores;
in response to determining that the previous impression scores do include at least a threshold number of previous impression scores, replacing a lowest previous impression score with the impression score corresponding to the advertisement request to create the updated previous impression scores.

5. The method of claim 1, wherein computing the allocation score for the eligible advertisement comprises computing a mathematical difference of the impression score corresponding to the advertisement request and the discount factor for the eligible advertisement.

6. The method of claim 1, wherein computing the allocation score for the eligible advertisement comprises computing ratio of the impression score corresponding to the advertisement request relative to the discount factor for the eligible advertisement.

7. The method of claim 1, wherein selecting, as a selected advertisement, an eligible advertisement to provide in response to the advertisement request, the selected advertisement being an eligible advertisement having a highest allocation score among the eligible advertisements.

8. The method of claim 1, wherein computing a discount factor for the eligible advertisement comprises computing the discount factor based on a function of exponentially weighted impression scores that correspond to previous impression scores for previous advertisement requests for which the eligible advertisement was provided, each previous impression score being exponentially weighted according a sort position corresponding to the impression score.

9. The method of claim 8, wherein computing a discount factor for the eligible advertisement comprises computing the discount factor based on a function of exponentially weighted impression scores that correspond to previous impression scores for previous advertisement requests for which the eligible advertisement was provided, each previous impression score being exponentially weighted according a sort position corresponding to the impression score, and each impression score being sorted in non-increasing order of impression score and such that a highest impression score is in a first sort position.

10. A computer-implemented method, comprising:
receiving, by a data processing apparatus, a resource request requesting a resource be allocated in response to the request;
identifying available resources that are available to allocate in response to the resource request;
for each of the available resources:
receiving a request score corresponding to the resource request, the request score representing a value resulting from providing the available resource in response to the resource request irrespective of values of previous resource requests for which the available resource was provided;
receiving a discount factor for the available resource, the discount factor being computed based on a function of weighted request scores corresponding to previous request scores for previous resource requests for which the available resource was provided, the weighted request scores being assigned weights that are inversely proportional to the previous request scores;
computing, by a data processing apparatus, an allocation score for the available resource, the allocation score being computed as a function of the request score corresponding to the resource request and the discount factor for the available resource, the allocation score representing a value resulting from allocation of the available resource in response to the resource request relative to values of previous resource requests for which the available resource was provided;
selecting, as a selected resource and by a data processing apparatus, an available resource to allocate in response to the resource request, the selected resource being an available resource having an allocation score that meets an allocation score threshold;
allocating, by a data processing apparatus, the selected resource in response to the request.

11. The method of claim 10, wherein identifying available resources that are available to allocate in response to the resource request comprises identifying processing apparatus that having available processing capacity.

12. The method of claim 10, wherein identifying available resources that are available to allocate in response to the resource request comprises identifying an audio file or a video file that matches the resource request.

13. A system, comprising:
a data store storing advertisement data and impression data, the advertisement data including eligible advertisement data identifying eligible advertisements that are eligible to be provided in response to an advertisement request, and the impression data including data representing previous impressions that have been allocated to eligible advertisements; and
an allocation subsystem coupled to the data store, the allocation subsystem comprising one or more data processing apparatus configured to receive eligible advertisement data and corresponding impression data in response to receipt of an advertisement request, receive impression scores corresponding to the advertisement request and representing values of the advertisement request to advertisers that provided the eligible advertisements, compute a discount factor based on a function of weighted previous impression scores corresponding to previous impressions, compute allocation scores based on the impression scores corresponding to the advertisement request and the discount factor, and select, based on the allocation score, an eligible advertisement to be provided in response to the advertisement request.

14. The system of claim 13, wherein the allocation subsystem is further configured to update the discount factor based on updated previous impression scores that include the impression score for the selected advertisement corresponding to the advertisements request.

15. The system of claim 13, wherein the allocation subsystem is further configured to determine whether the previous impression scores include at least a threshold number of previous impression scores and include the impression score for the selected advertisement corresponding to the advertisement request when the previous impression scores do not include at least a threshold number of previous impression scores.

16. The system of claim 15, wherein the allocation system is further configured to replace a lowest previous impression score with the impression score for the selected advertisement corresponding to the advertisement request when the previous impression scores include at least the threshold number of previous impression scores.

17. The system of claim 13, wherein the allocation subsystem is further configured to compute the allocation score for the eligible advertisements as a mathematical difference of the impression score corresponding to the advertisement request and the discount factor for the eligible advertisement.

18. The system of claim 13, wherein the allocation subsystem is further configured to compute the discount factor for an eligible advertisement based a function of exponentially weighted impression scores that correspond to previous impression scores for previous advertisement requests for which the eligible advertisement was provided, each previous impression score being exponentially weighted according a sort position corresponding to the impression score.

19. The system of claim 18, wherein the allocation subsystem is further configured to compute the discount factor for an eligible advertisement based on a function of exponentially weighted impression scores that correspond to previous impression scores for previous advertisement requests for which the eligible advertisement was provided, each previous impression score being exponentially weighted according a sort position corresponding to the impression score, and each impression score being sorted in non-increasing order of impression score and such that a highest impression score is in a first sort position.

20. A computer readable medium encoded with a computer program comprising instructions that when executed operate to cause a computer to perform operations:
receiving, by a data processing apparatus, an advertisement request requesting an advertisement be provided in response to the advertisement request;
identifying eligible advertisements that are eligible to be provided in response to the advertisement request;
for each of the eligible advertisements:
receiving an impression score corresponding to the advertisement request, the impression score representing a value resulting from providing the eligible advertisement in response to the advertisement request irrespective of values of previous advertisement requests for which the eligible advertisement was provided;
computing a discount factor for the eligible advertisement, the discount factor being computed based on a function of weighted impression scores corresponding to previous impression scores for previous advertisement requests for which the eligible advertisement was provided, the weighted impression scores being assigned weights that are inversely proportional to the previous impression scores;
computing, by a data processing apparatus, an allocation score for the eligible advertisement, the allocation score being computed as a function of the impression score corresponding to the advertisement request and the discount factor for the eligible advertisement, the allocation score representing a value resulting from providing the eligible advertisement in response to the advertisement request relative to values of previous advertisement requests for which the eligible advertisement was provided;
selecting, as a selected advertisement and by a data processing apparatus, an eligible advertisement to provide in response to the advertisement request, the selected advertisement being an eligible advertisement having an allocation score that meets an allocation score threshold;
providing, by a data processing apparatus, the selected advertisement in response to the request.

21. A computer-implemented method, comprising:
receiving, by a data processing apparatus, an advertisement request requesting an advertisement be provided in response to the advertisement request;
identifying eligible advertisements that are eligible to be provided in response to the advertisement request;
for each of the eligible advertisements:
receiving an impression score corresponding to the advertisement request, the impression score representing a value resulting from providing the eligible advertisement in response to the advertisement request irrespective of values of previous advertisement requests for which the eligible advertisement was provided;
computing a discount factor for the eligible advertisement, the discount factor being computed as an average of previous impression scores for previous advertisement requests for which the eligible advertisement was provided;
computing, by a data processing apparatus, an allocation score for the eligible advertisement, the allocation score being computed as a function of the impression score corresponding to the advertisement request and the discount factor for the eligible advertisement, the allocation score representing a value resulting from providing the eligible advertisement in response to the advertisement request relative to values of previous advertisement requests for which the eligible advertisement was provided;
selecting, as a selected advertisement and by a data processing apparatus, an eligible advertisement to provide in response to the advertisement request, the selected advertisement being an eligible advertisement having an allocation score that meets an allocation score threshold; and
providing, by a data processing apparatus, the selected advertisement in response to the request.
